(19) United States
(12) Patent Application Publication
(10) Pub. No.: US 2007/0209760 A1
(43) Pub. Date: Sep. 13, 2007

(54) Apparatus for forming tires utilizing rotary base

(75) Inventor: Goo Yeon Hwang, Seoul (KR)

Correspondence Address: GWIPS;PETER T. KWON, P.O. BOX 231630, CENTERVILLE, VA, 20120, US

(73) Assignee: Woo Sung Mfg. Co., Ltd.

(21) Appl. No.: 11/709,136

(22) Filed: Feb. 21, 2007

(30) Foreign Application Priority Data
Mar. 9, 2006 (KR) 10-2006-0022174

(51) Int. Cl. B29D 30/08

(52) U.S. Cl. 156/397; 156/130; 156/405.1; 156/406.2

(57) ABSTRACT

An apparatus is invented for forming a tire tread on the surface of a prototype tire that is pre-fabricated during the tire manufacturing processes. The apparatus for forming the tire comprises six forming devices disposed above the circular rotary base for securing the prototype tire, a transporting compression ring disposed around the rotary base for supplying and compressing an iron core belt onto the prototype tire of the forming device, and a first extruder, a second extruder, a third extruder, and a fourth extruder for extruding a ribbon-shaped rubber band to form a tire tread on the surface of the prototype tire. Accordingly, by constructing a plurality of extruders around the circular rotary base, the installation space can be smaller than the conventional prototype tire forming apparatus, the device fabricating cost can be reduced, and various shaped tires can be fabricated.

### BACKGROUND OF THE INVENTION

1. Field of the Invention

The present invention relates to an apparatus for forming tires utilizing a rotary base, and more particularly, to an apparatus in which a tire-tread, i.e. the portion directly contacting the ground, is formed on a prefabricated prototype tire during the tire manufacturing processes.

2. Description of the Related Art

In general, as shown in FIG. 2, the tire tread 10 is constructed of a cap-ply 11, an under tread 12, a tread 13, and a reinforcing portion 14, and it is fabricated by winding the tire tread 10 around the prototype tire corresponding to a main body of the tire.

The conventional device for forming the tire tread on the prototype tire has the disadvantages of high initial capital cost and large required space because the construction is complex and it is a very large arrangement, and design modifications and facilities changes are very difficult when required due to a change in the product design or the size of the tire.

Hereinafter, the conventional tire forming apparatus for forming a tire tread on a prototype tire will be described.

FIG. 1 is a constructional view showing a device for fabricating a tire tread in the conventional tire forming apparatus.

As shown in FIG. 1, when several rubber materials are respectively extruded from a first extruder 1, a second extruder 2, a third extruder 3, and a fourth extruder 4 to a head 5, the synthetic rubber extruded from the respective extruders 1, 2, 3, and 4 are merged so that the tire tread is continuously extruded from the head 5, and the extruded tire tread 10 is transported by means of a conveyor 9 through a balance 6, a cooling device 7, a length measuring device 22, and a cutter 8 to thereby fabricate a tire tread 10 having a shape as shown in FIG. 2.

As shown in FIG. 3, when the tire tread 10 having an iron core belt 20 attached on the prototype tire 19, which is secured to the forming device 30, is transported to a transporting compression ring 15, after attaching the iron core belt 20 under the tire tread 10, a compression cylinder 17 of the transporting compression ring 15 is operated to cause a holder 18 to compress the tire tread 10 onto the surface of the prototype tire 19.

In this instant, as shown in FIG. 4, both end portions of the tire tread 10 are compressed by a side compression roller 21 to attach them to the prototype tire 19, since both end portions of the flat tire tread 10 are not attached to the semicircular shaped surface of the prototype tire 19.

As described above, the conventional tire forming apparatus has disadvantages in that the structure is complex, thereby requiring a large facility, the cost of the mechanical equipment is high, and it is difficult to produce various types of tires, since the separate tire tread 10 was fabricated and the tire was formed by using the transporting compression ring 15 and the side compression roller 21.

### SUMMARY OF THE INVENTION

Therefore, the present invention has been made in view of the above problems occurring in the prior art, and an object of the present invention is to provide a tire forming apparatus capable of forming tires of various sizes and shapes, and requiring a smaller space claim than ever before by radially disposing the tire forming devices above a circular rotary base, and disposing a transporting compression ring and first through fourth extruders around the rotary base to thereby simplify the construction.

To accomplish the above objects, according to the present invention, there is provided a tire forming apparatus using a rotary base, comprising: a plurality of forming devices radially disposed above a circular rotary base for securing a prototype tire; a transporting compression ring for supplying and compressing an iron core belt onto the prototype tire secured to the forming device; and a plurality of extruders disposed at the outside of the rotary base for extruding ribbon-shaped rubber bands to form a tire tread on the prototype tire.

### BRIEF DESCRIPTION OF THE DRAWINGS

FIG. 1 is a constructional view showing a device for fabricating a tire tread in a conventional tire forming apparatus.

FIG. 2 is a cross-sectional view taken along line B-B of FIG. 1.

FIG. 3 and FIG. 4 are cross-sectional views showing states of attaching the tire tread to the prototype tire by using a conventional compression ring and the side compression roller.

FIG. 5 is a plan view showing the tire construction of the present invention.

FIG. 6 is a front view showing the tire construction of the present invention.

FIG. 7 is a cross-sectional view showing a state of mounting the prototype tire to the tire forming device.

FIG. 8 is a cross-sectional view showing a state of supplying and attaching the iron core belt to the prototype tire by using the transporting compression ring.

FIG. 9 is a view showing a state of winding rubber bands extruded from the extruder around the prototype tire.

FIG. 10 is a partial cross-sectional view of the tire forming apparatus of the present invention.

FIG. 11 is a plan cross-sectional view showing the construction of upper and lower bases of the tire forming apparatus of the present invention.

FIG. 12 and FIG. 13 are views showing states of the tire forming apparatus of the present invention moving in all directions including forward, rearward, leftward and rightward and the rotating of an arm shaft.

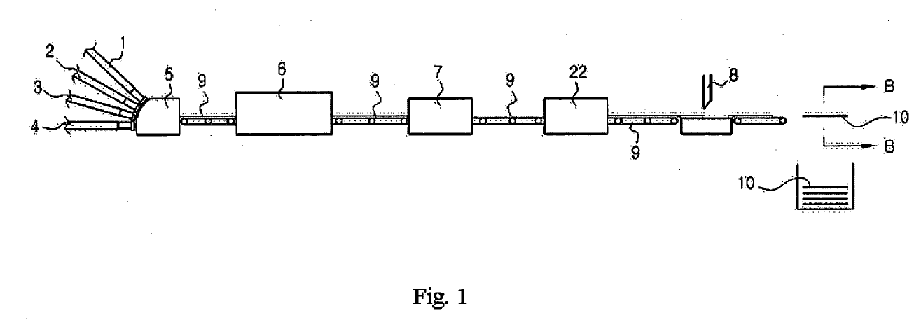

### DETAILED DESCRIPTION OF THE PREFERRED EMBODIMENT

Reference will now be made in detail to the preferred embodiment of the present invention with reference to the attached drawings.

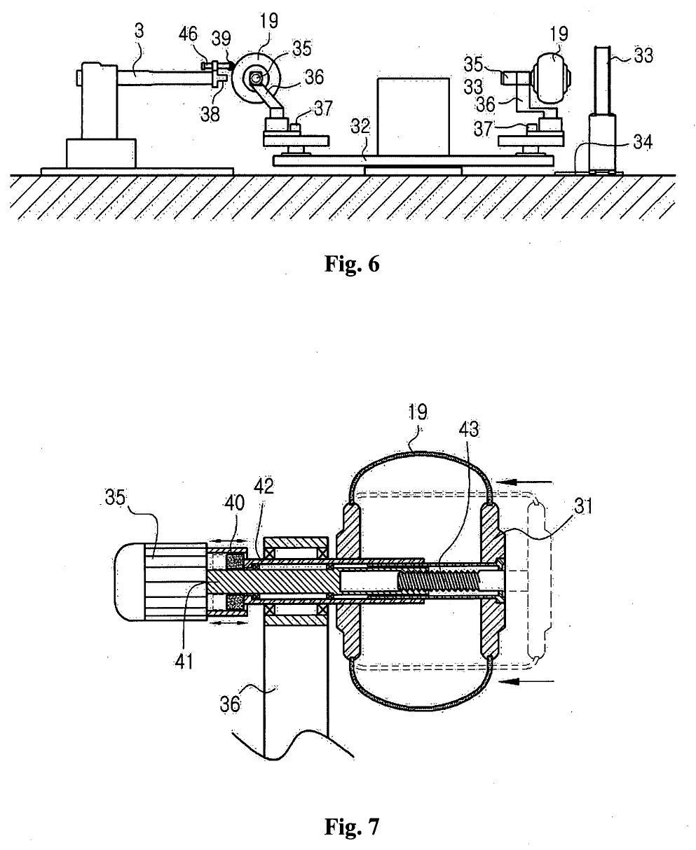

Referring to FIGS. 5 and 6, they show a plan view and a front view respectively for the tire construction of the present invention.

As shown in FIGS. 5 and 6, six forming devices 30 are radially disposed above a rotary base 32, and a transporting compression ring 33 and four extruders 1, 2, 3, and 4 are disposed at the outside of the rotary base 32 to correspond to a forming device 30 disposed on the rotary base 32 so as to fabricate the most general type of a tire according to an embodiment of the present invention.

The prototype tire 19 is attached to the forming device 30 at the point designated by “S” among the forming devices 30 disposed at the upper portion of the rotary base 32. FIG. 7 is a cross-sectional view showing the state of attaching the prototype tire 19 to the forming device 30.

As shown in FIG. 7, when the prototype tire 19 is attached and the activation motor 35 is operated to rotate an inside shaft 41, a fixed plate 31 threaded to the inside shaft 41 by means of a screw 43 is drawn to make the flat prototype tire 19 into a semicircular shape. In this instant, the rotary base 32 is rotated to move the forming device 30 disposed at the position “S” of FIG. 5 to the transporting compression ring 33.

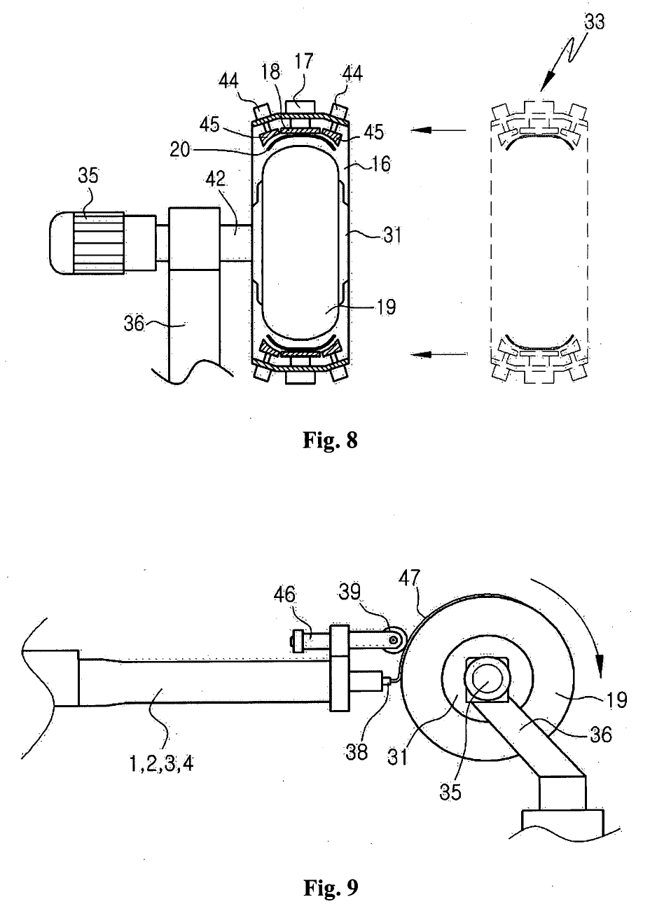

As shown in FIG. 8, the transporting compression ring 33 comprises a compression cylinder 1 and side compression cylinders 44 disposed on a circular ring frame 16 in the radial direction such that the side compression cylinders 44 are disposed at both sides of the compression cylinder 17. The compression cylinder 17 is provided with a flat holder 18, and the side compression cylinder 44 is provided with a side holder 45 formed with a curve to correspond to a curved portion of the prototype tire 19.

As shown in FIGS. 6 and 8, the transporting compression ring 33 is moved along a rail 34 to supply and compress the iron core belt 20 to the prototype tire 19 to thereby compress the iron core belt 20 onto the surface of the prototype tire 19. In this instant, as shown in FIG. 8, the iron core belt 20 is tightly compressed onto the curved surface portion of the prototype tire 19 by means of a pair of side holders 45.

When the compression of the iron core belt 20 is completed, the rotary base 32 is rotated to move the forming device 30 at the transporting compression ring 33 to the first extruder 1. In this instant, as shown in FIG. 5, an arm 36 of the forming device 30 is rotated to cause the surface of the prototype tire 19 to face a nozzle 38 of the first extruder 1.

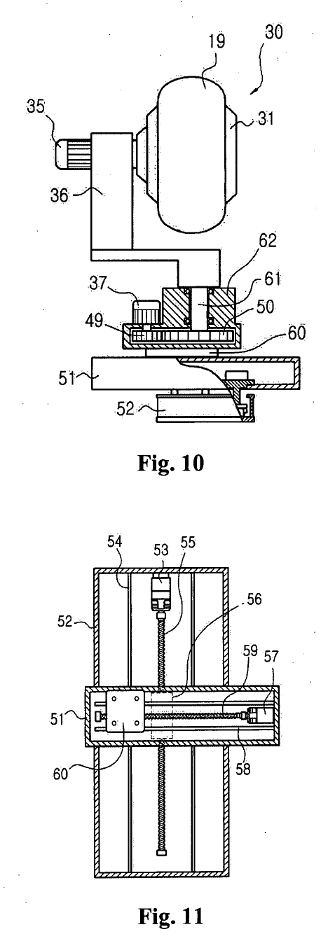

As shown in FIG. 10, the arm 36 of the forming device 30 is rotated such that a driving gear 49 is rotated by the activation of the rotation motor 37, and a follower gear 50 is rotated by the rotation of the driving gear 9, because the arm shaft is joined to the follower gear 50.

Also, as shown in FIG. 7, the prototype tire 19 secured to the forming device 30 is rotated by the activation motor 35, such that a clutch 40 slides so as to adhere to one side of an outside shaft 42, and the outside shaft 42 is rotated together with the inside shaft 41 by the operation of the activation motor 35 to thereby rotate the prototype tire 19.

In addition, when the prototype tire 19 is rotated, a belt shaped rubber band 47 is continuously extruded, and the extruded rubber band 47 is attached to the surface of the prototype tire 19. In this instant, the compression roller 39 disposed at the first extruder 1 compresses the rubber band 47 onto the prototype tire 19 so that the prototype tire 19 can be more tightly compressed. The compression force of the compression roller 39, which acts on the rubber band 47, can be adjusted using a cylinder 46.

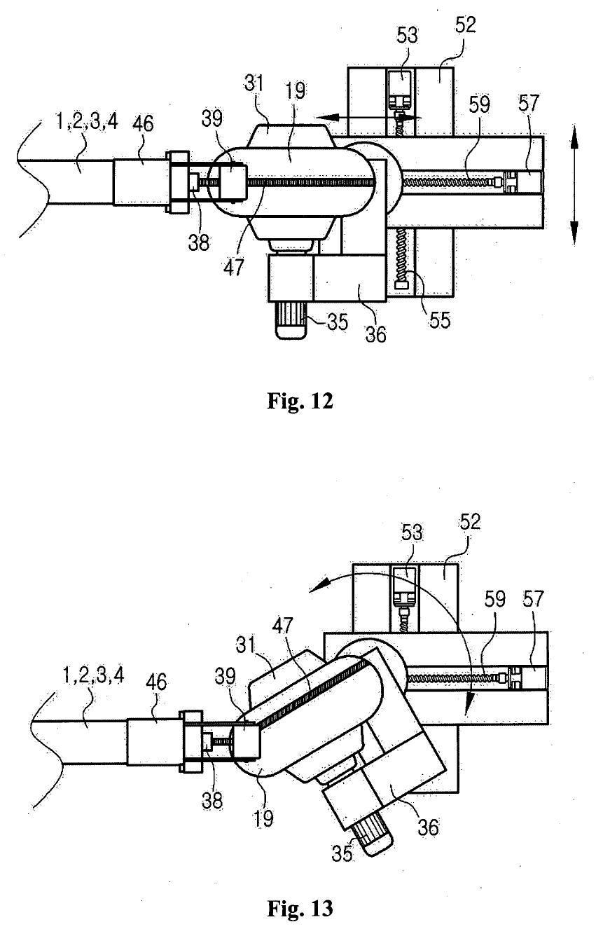

As described above, as shown in FIG. 11, a cap-ply 11 is formed on the upper portion of the iron core belt 20 by winding the rubber band 47 extruded through the first extruder 1 around the prototype tire 19. In this instant, as shown in FIG. 13, the prototype tire 19 can wind the rubber band 47 uniformly at an accurate position around the prototype tire 19 through the rotation of the arm 36 by means of the rotation motor 37 of the forming device 30, and through the movement of the forming device 30 in the forward, rearward, leftward and rightward directions as shown in FIG. 12.

The movement of the forming device 30 in the forward, rearward, leftward and rightward directions can be achieved through the upper and lower bases 51 and 52, to which the arm 36 of the forming device 30 is secured, as shown in FIG. 11.

As shown in FIG. 11, screws 55 and 59, which are rotated by a pair of guide rods 54 and 58 and base motors 53 and 57, are disposed at the inside of the upper and lower bases 51 and 52, so that the upper base 51, which is threaded to a ball nut 56 of the screw 55, moves in the axial direction of the screw 55 of the lower base 52 by the operation of the base motor 53 of the lower base 52.

The body 62 of the forming device 30 fastened to the joint plate 60 moves in all directions including the forward and rearward directions, and the leftward and rightward directions as shown in FIG. 12, together with the movement of the joint plate 60, which is threaded to the screw 59, in the axial direction of the screw 59 by the operation of the base motor 57 of the upper base 51.

When the cap-ply 11 is formed by winding the rubber band 47 extruded from the first extruder 1 around the prototype tire 19, the rotary base 32 is rotated to move the forming device 30 disposed at the first extruder 1 to the second extruder 2. Then, the rubber band 47 extruded from the second extruder 2 is wound around the prototype tire 19 to form an under tread 12 at the upper portion of the cap-ply 11.

When the under tread 12 is formed by winding the rubber band 47 extruded from the second extruder 2 around the prototype tire 19, the rotary base 32 is rotated to move the forming device 30 disposed at the second extruder 2 to the third extruder 3. Then, the rubber band 47 extruded from the third extruder 3 is wound around the prototype tire 19 to thereby form a tread 13 on the upper portion of the under tread 12.

When the tread 13 is formed by winding the rubber band 47 extruded from the third extruder 3 around the prototype tire 19, the rotary base 32 is rotated to move the forming device 30 disposed at the third extruder 3 to the fourth extruder 4. Then, the rubber band 47 extruded from the fourth extruder 4 is wound around the prototype tire 19 to thereby form a reinforcing portion 14 at both sides of the tread 13 to thereby achieve the formation of the tire tread 10 on the prototype tire 19.

When the rubber band 47 extruded from the fourth extruder 4 is wound around the prototype tire 19 to form the reinforcing portion 14, then the rotary base 32 is rotated to move the forming device 30 disposed at the fourth extruder.4 to a position designated by “S” shown in FIG. 5, and the completed tire is drawn from the forming device 30, and a prototype tire 19 to be newly fabricated is put into position.

In other words, since the tire tread 10 is formed on the prototype tire 19 of the respective forming device 30 by winding the rubber band 47 extruded from the respective extruders 1, 2, 3, and 4 while rotating the rotary base 32 disposed between the six forming devices 30, the construction of the tire forming apparatus is simple and a small installation space is sufficient, and it is possible to fabricate various sizes and shapes of tires.

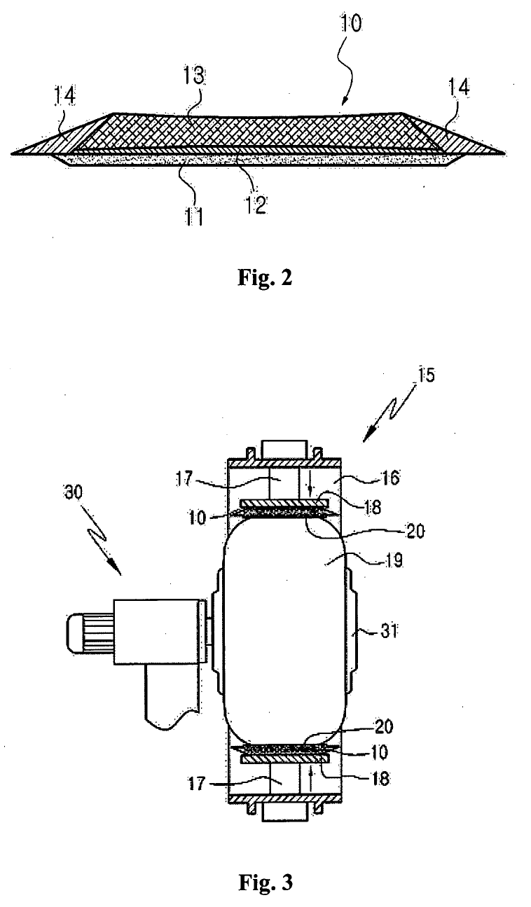

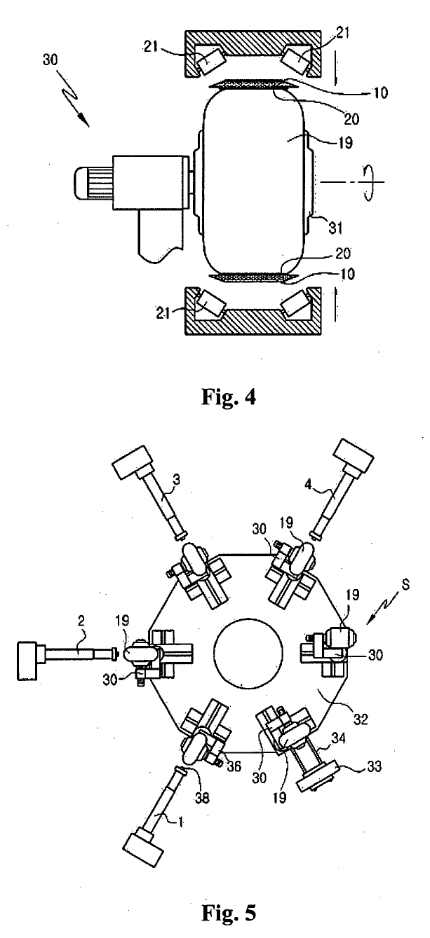

While the present invention is constructed with six forming devices 30 disposed at the upper portion of the rotary base 32 and four extruders 1, 2, 3, and 4 are disposed around the rotary base 32 to form a most general type of tire tread 10 as shown in FIG. 2, the number of the extruders and the forming devices 30 can be varied according to the requirements of the fabricating process.

Consequently, the technical gist of the present invention resides in that a predetermined number of forming devices 30 for securing the prototype tire 19 are disposed at the upper portion of the rotary base 32 according to the process, and the transporting compression ring 33 for supplying and compressing the iron core belt 20 onto the prototype tire 19 secured to the forming device 30, as well as a predetermined number of extruders 1, 2, 3 and 4 for forming the tire tread 10 on the prototype tire 19 by extruding the ribbon-shaped rubber bands 47, are all disposed around the outside of the rotary base 32.

Moreover, the transporting compression ring 33 is constructed such that the compression cylinder 17 and the side compression cylinders 44 are disposed on a ring frame 16 in the radial direction in a desired number, in order to dispose the side compression cylinders 44 formed with curved side holders 45 at both sides of the compression cylinder 17.

Also, the forming device 30 is constructed such that the arm 36 is rotated by means of the geared engagement between the driving gear 49 of the rotation motor 37 and the following gear 50 coupled with the shaft 61 of the arm 36, and the arm 36 is constructed to move in all directions including the forward, rearward, leftward and rightward directions by means of the threaded engagement of the upper base 51 with the screw 55 rotated by the base motor 53 of the lower base 52, and by means of the threaded engagement of the body 62 with the screw 59 rotated by the base motor 57 of the upper base 51.

As described above, the tire forming apparatus according to the present invention is simpler in construction as compared to the conventional tire forming apparatus, so that production cost can be reduced, and installation space can be small, and it is possible to fabricate tires of various sizes and shapes.

While the present invention has been described with reference to the particular preferred embodiments, it is not to be restricted by the embodiments but only by the appended claims. Also, it is to be appreciated that those skilled in the art can change or modify the embodiments without departing from the scope and spirit of the present invention, and such modifications are wholly encompassed by the scope of the appended claims.

What is claimed is:

1. A tire forming apparatus using a rotary base, comprising:
a plurality of forming devices (30) radially disposed above a circular rotary base (32) for securing a prototype tire (19),
a transporting compression ring (33) for supplying and compressing an iron core belt (20) onto the prototype tire (19) secured to the forming device (30), and a plurality of extruders (1, 2, 3 and 4) disposed around the outside of the rotary base (32) for extruding ribbon-shaped rubber bands (47) to form a tire tread (10) on the prototype tire (19).

2. The tire forming apparatus using a rotary base according to claim 1, wherein the transporting compression ring (33) is constructed of a plurality of compression cylinders (17) and side compression cylinders (44) disposed on a ring frame 16 in the radial direction such that the side compression cylinders (44) formed with curved side holders (45) are disposed at both sides of the compression cylinder (17).

3. The tire forming apparatus using a rotary base according to claim 1, wherein the forming device (30) is constructed such that an arm (36) can be rotated by means of the geared engagement between a driving gear (49) of a rotation motor (37) and a follower gear (50) with which a shaft (61) of the arm (36) is engaged, and the arm is moved in all directions by means of the threaded engagement of an upper base (51) with a screw (55) rotated by a base motor (53) of a lower base (52) and by means of the threaded engagement of a body (62) with a screw (59) rotated by a base motor (57) of the upper base (51).
